(19) United States
(12) Patent Application Publication
(10) Pub. No.: US 2009/0063438 A1
(43) Pub. Date: Mar. 5, 2009

(54) REGULATORY COMPLIANCE DATA SCRAPING AND PROCESSING PLATFORM

(75) Inventors: George J. Awad, Philadelphia, PA (US); Amany Mansour-Awad, Philadelphia, PA (US)

Correspondence Address: DESIGN IP, P.C., 5100 W. TILGHMAN STREET, SUITE 205, ALLENTOWN, PA, 18104, US

(73) Assignee: IAMG, LLC, Philadelphia, PA (US)

(21) Appl. No.: 12/199,817

(22) Filed: Aug. 28, 2008

Related U.S. Application Data
(60) Provisional application No. 60/968,382, filed on Aug. 28, 2007.

(51) Int. Cl. G06F 7/06; G06F 17/30

(52) U.S. Cl. 707/4; 707/E17.014

(57) ABSTRACT

Systems and methods are provided allowing the scraping and processing of regulatory compliance data (e.g., validation data). In an illustrative implementation, a data scraping and processing computing environment comprises a data scraping and processing engine operable to process/scrape legacy regulatory compliance data stored on one or more cooperating legacy data stores according to one or more selected data scraping guidelines. The data scraping guidelines can be defined according to one or more data types stored on the one or more cooperating legacy data stores. The one or more data scraping guidelines are defined by the data scraping and processing engine based on one or more characteristics of the identified legacy data stores. The data scraping and processing engine processes the stored data scrape and aggregate selected legacy regulatory compliance data for use in populating one or more selected regulatory compliance data templates.

### CLAIM OF PRIORITY AND CROSS REFERENCE

This application cross references and claims priority to U.S. Provisional Patent Application, Ser. No. 60/968,382, filed on Aug. 28, 2007, entitled, “REGULATORY COMPLIANCE DATA SCRAPING AND PROCESSING PLATFORM,” the entirety of which is herein incorporated by reference.

### BACKGROUND

Validation is a process that pharmaceutical and biotechnology companies must complete before they can be licensed by the FDA to manufacture a drug. Validation provides the pharmaceutical/bio-technology company with documented evidence that their facility (building) and equipment will consistently produce a product (drug) that meets the product's pre-determined quality requirements.

Validation usually requires writing a protocol (test procedure) that is designed to test every critical variable on a piece of equipment or the process for making a drug. Each test is designed to examine both the normal operating parameters and the “worst case” conditions or limits of the equipment or process. The test is also designed to be repeated several times (usually three times) to determine whether the equipment or process is consistent and reliable.

Validation efforts are often arduous and expensive. In a typical validation life cycle, the equipment, facility, and/or process is/are first identified. The equipment, facility, and/or process is/are then described in accordance with validation guidelines to generate a validation protocol. The validation protocol, inter alia, describes the equipment, facility, and/or process that is/are being validated along with one or more tests that will be applied to the equipment, facility, and/or process that will ensure that the equipment, facility, and/or process satisfy pre-determined quality and safety standards. The level of detail required in a typical validation protocol can be mind-numbing. It is not hard to imagine that such efforts are both time and labor intensive. Moreover, there is additional significant time and labor expended in managing the workflow between validation personnel and project personnel (e.g. project managers, engineers, etc.) in the validation life cycle.

Current practices allow for the central storage of regulatory compliance data (e.g., validation/clinical trial data) in a central data repository. Such repositories can co-exist in a similar geographic location (i.e., within an organization's building) or can be dispersed at geographically disparate locations (i.e., across an organization's various locations). With current practices, the data's gatekeeper (e.g., validation personnel) are tasked with updating legacy stored validation data to bring it in compliance with one or more regulatory compliance data rule changes. For example, a new regulatory compliance rule change can require that validation data relating to autoclaves be and stored according to three different temperature ranges compared to the previously required two temperature ranges. With current practices, the validation data gatekeeper is required to often manually search all of the legacy validation data to identify which of the legacy stored validation data is directed and/or contains autoclave validation data. Once identified, the validation data gatekeeper is then tasked with reformatting the stored legacy validation data according to the new rule change (e.g., a new validation protocol template). Additionally, the validation data gatekeeper, with current practices, will be tasked with re-testing the described autoclaves to generate test data to populate the new validation protocol template for the legacy autoclaves. Such practices are arduous and resource intensive.

From the foregoing, it is appreciated that there exists a need for systems and methods that ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The herein described systems and methods provide a computer-implemented interactive system and methods allowing for the scraping and processing of regulatory compliance data (e.g., validation data, clinical research data, etc.). In an illustrative implementation, a data scraping and processing computing environment comprises a data scraping and processing engine operable to process legacy regulatory compliance data stored on one or more cooperating legacy data stores according to one or more selected data scraping guidelines. In the illustrative implementation, the data scraping guidelines can be defined according to one or more data types stored on the one or more cooperating legacy data stores.

In an illustrative operation, one or more cooperating data stores containing legacy regulatory data are identified by the data scraping and processing engine. In the illustrative operation, one or more data scraping guidelines are defined by the data scraping and processing engine based on one or more characteristics of the identified legacy data stores. Illustratively, the data scraping and processing engine processes the stored data of the identified legacy data stores to scrape and aggregate selected legacy regulatory compliance data. The aggregated scraped legacy regulatory compliance data can then be processed by the data scraping and processing engine such that the scraped data populates one or more selected regulatory compliance data templates.

In an illustrative operation, one or more regulatory compliance data templates are defined based on one or more rule changes to one or more regulatory compliance rules. In the illustrative operation, the data scraping and processing engine can scrape legacy regulatory compliance data stored on one or more cooperating legacy regulatory compliance data stores and aggregate the scraped data for use in populating the one or more regulatory compliance data templates.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of an exemplary computing environment in accordance with an illustrative implementation of the herein described systems and methods.

FIG. 2 is a block diagram of an exemplary networked computing environment in accordance with an illustrative implementation of the herein described systems and methods.

FIG. 3 is a block diagram showing the cooperation of exemplary components of an illustrative implementation in accordance with the herein described systems and methods.

FIG. 4 is a block diagram showing an illustrative block representation of an illustrative implementation of an exemplary regulatory compliance data scraping and processing environment in accordance with the herein described systems and methods.

FIG. 5 is a block diagram of one or more processes operable on exemplary legacy regulatory compliance data in accordance with the herein described systems and methods.

FIG. 6 is a flow diagram of illustrative processing performed to scrape and/or process legacy regulatory compliance data in accordance with the herein described systems and methods; and

FIG. 7 is a flow diagram of other illustrative processing performed scrape and/or process legacy regulatory compliance data in accordance with the herein described systems and methods.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,” “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Illustrative Computing Environment

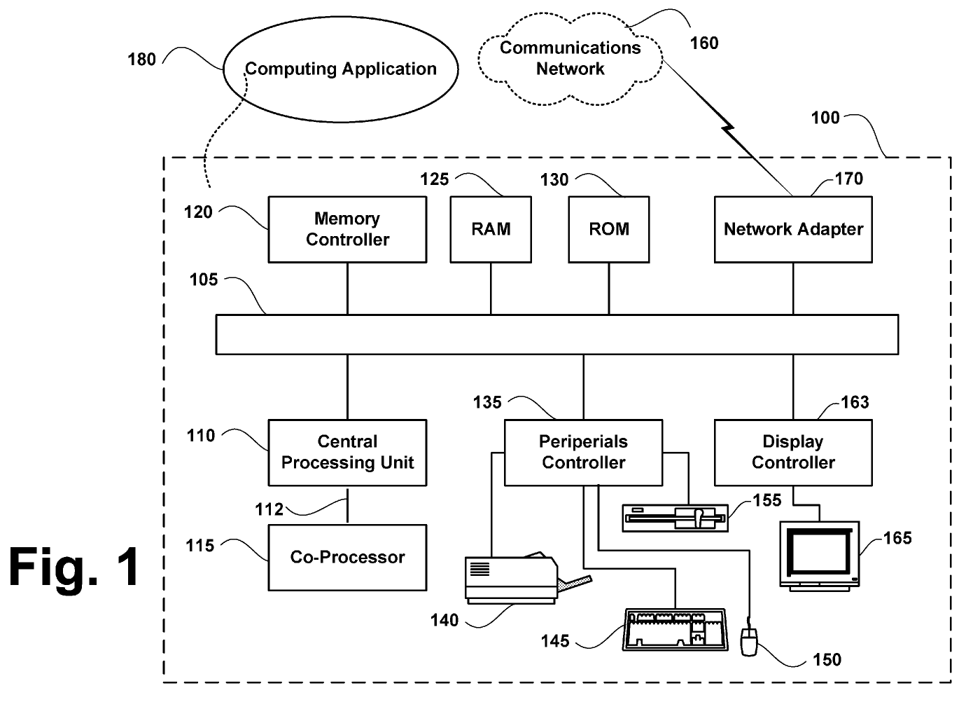

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, audio, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment

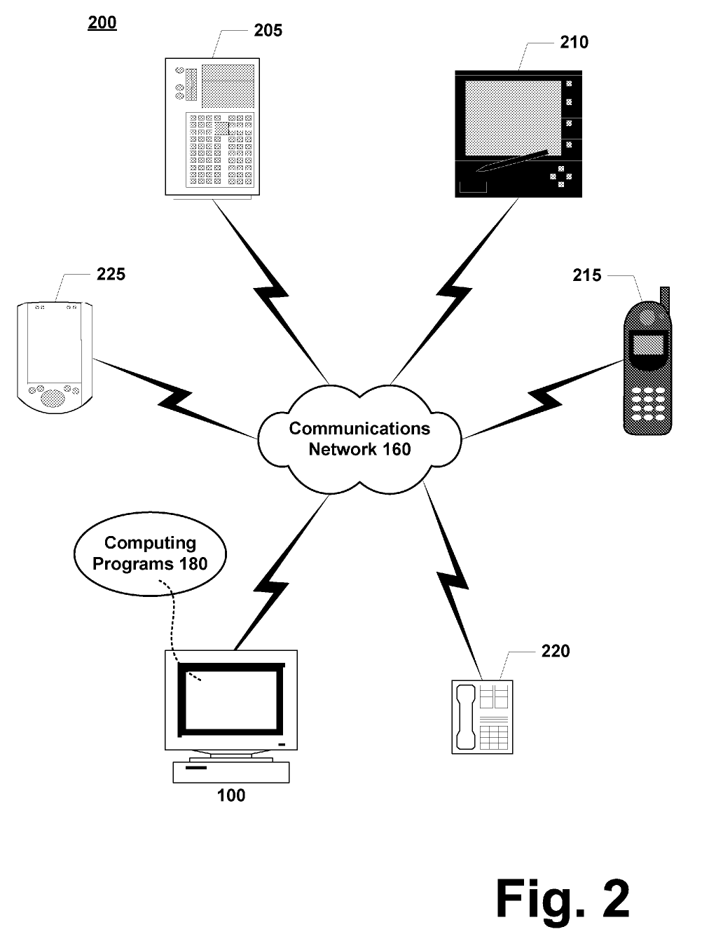

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, personal digital assistant 225. In a network environment in which the communications network 160 is the Internet, for example, server 205 can be dedicated computing environment servers operable to process and communicate data to and from client computing environments 100, 210, 215, 217, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### Data Scraping And Processing Overview

Generally data scraping applications operate on data stores to identify data and/or data types. Once identified, the data and/or data/types can be reorganized, reclassified, manipulated, further stored, modified, and/or changed according to a selected data model/paradigm. A simple example of data scraping can be found in most MP3/digital media management applications (e.g., iTunes, Windows Media, Real Player, etc.) that operatively perform one or more searches on a cooperating data store (e.g., hard drive, connected medial player, media server) to find data and/or data types (e.g., MP3, MP4, JPEG, GIF, WMA files) to import into the digital media management application for further processing (playback, categorization, modification, reclassification, etc.). Such applications are extremely useful to data owners as they can readily and easily find specific data and/or data types for use in one or more desired applications (i.e., for additional processing)

Enterprise data scraping can be even more powerful as volumes of data stores (e.g., SANs, File servers, Mail Servers, Web Servers, etc.), located in geographically disparate regions, can be processed to identify data and/or data types for subsequent processing (e.g., reclassification, categorization, authentication, re-authorization, management, subsequent storage, and/or manipulation) as part of a single project manifest.

In the context of validation efforts, data scraping can serve as necessary tool to allow large organizations maintaining large volumes of legacy validation data (i.e., housed in geographic disparate locations and across various sub-networks) to easily locate, identify, retrieve, and further manipulate (e.g., format, authenticate, categorize, redefine) such validation data to comply with newly promulgated and implemented rules and regulations.

Data scraping is also effective for enterprises that maintain central repositories of validation data. With current practices and data management solutions employing central repositories (e.g., Lotus Notes, SAP, IBM), validation data can be easily identified but is not easily manipulated to generate data that complies with new regulations/rules. Rather, the legacy repository data would most likely have to be regenerated according to the new regulations/rules.

Current validation data management operations consider that, typically, each location with a given organization will maintain a local validation data library (e.g., file server, mail server, etc.) to store validation data. For more sophisticated enterprises, a central validation data repository can be maintained to allow for the central storage and management of data (e.g., according to a specific data management application—Lotus Notes, SAP, IBM, etc.). In either case, data cannot be easily manipulated according to a data model to accommodate for changes in validation rules and/or regulations. Also for the non-central repository enterprises, data validation data cannot be easily identified and located (i.e., only with knowledge of each individual location can a data owner be confident of where validation data resides). For the later, significant inefficiencies result as validation data is not easily shared among various parts of an organization.

The herein described systems and methods aim to ameliorate the shortcomings of existing practices by providing, a compliance/clinical data scraping, processing, and management platform. In an illustrative implementation, the regulatory compliance data scraping/manipulation engine can cooperate with local and/or central regulatory compliance data stores to scrape for regulatory compliance data which would be manipulated according to a data model (not shown) for further storage. The exemplary data model could be based on a business rule assessment to identify how legacy regulatory data should be further manipulated to achieve one or more desired goals (e.g., validation data audit, validation data authentication, reformatting validation data to comply with new rules and/or regulations, etc.).

In an illustrative operation, desired regulatory compliance/clinical trial data can be identified to populate selected presentation templates (i.e., presentation templates compliant with various agency (e.g., FDA) regulatory compliance rules and regulation that allow for the presentation of regulatory compliance/clinical trial data consistent with agency rules and regulations). An exemplary data scraping/processing engine can then be deployed across one or more cooperating data stores (e.g., geographically disparate data stores of an enterprise computing environment) to locate, using one or more exemplary correlation/association algorithms, desired regulatory compliance/clinical trial data. In the illustrative operation, exemplary data scraping/processing engine can process various data types and formats including but not limited to meta-data as part of the desired data location operations.

Once the desired data and/or data types are identified, they can be aggregated for processing by the data scraping/processing engine. Illustratively, the data scraping/processing engine can process the “scraped” data to populate the selected presentation templates. As part of the illustrative processing, the data scraping/processing engine can generate a taxonomy for the populated template to accommodate any subsequent changes to the selected templates. Further, in the illustrative implementation and/or operation, responsive to a request for one or more regulatory compliance/clinical trial data, the data scraping/processing engine can illustratively operate to generate on-the-fly (or alternatively retrieve from a repository of already generated templates) one or more templates to satisfy the request.

Stated differently, in the illustrative operation, the data scraping/processing engine illustratively operates to generate new relationships between the identified, scrapped data (i.e., illustratively using one or more data correlation, association algorithms) to reflect any changes to one or more of the selected templates.

It is appreciated that data store can comprise any of local or enterprise hard-drives, external micro-drives, flash memory data storage instruments, and/or floppy drives. Further it is appreciated that the desired data can exist in any of database applications, electronic files, flat files, machine readable data, binary data having one or more data formats comprising e-mail, word-processing data, spreadsheet data, text data, HTML data, XML data, instant messaging data, and any other electronic data format.

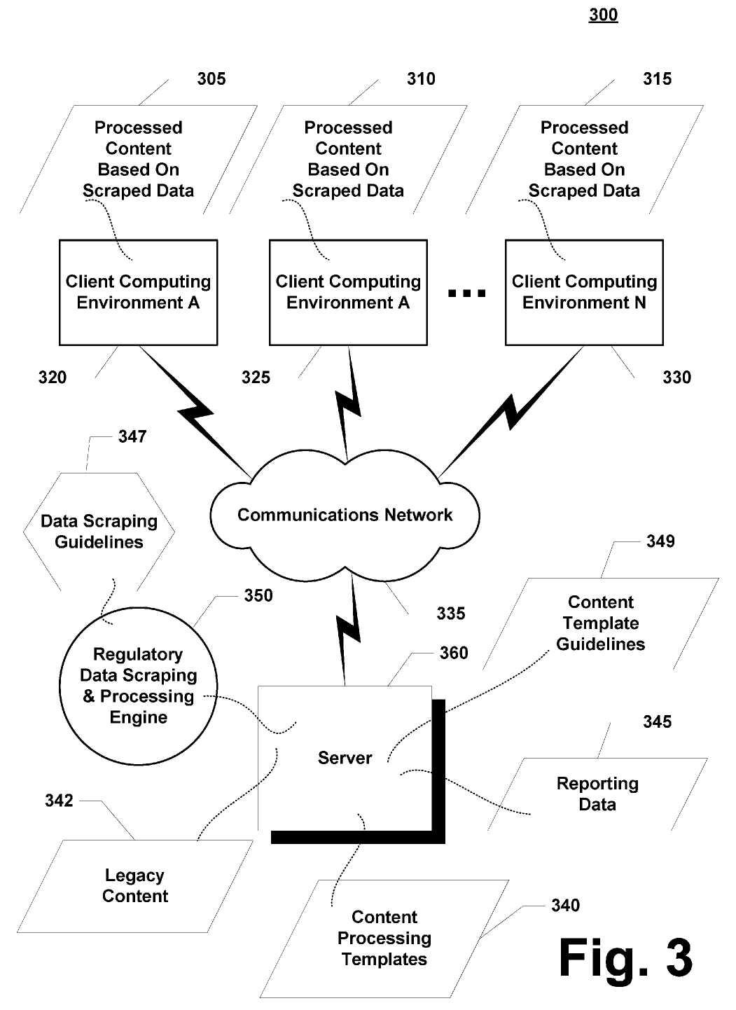

FIG. 3 shows an illustrative implementation of exemplary regulatory compliance data scraping and processing environment 300. As is shown in FIG. 3, exemplary regulatory compliance data scraping and processing environment 300 comprises client computing environment A 320, client computing environment B 325, up to and including, client computing environment N 330, communications network 335, server computing environment 360, regulatory data scraping and processing engine 350, data scraping guidelines 347, legacy content 342, content processing templates 340, reporting data 345, and content template guidelines 349. Also, as is shown in FIG. 3, content management and distribution environment 300 can comprise processed content based on scraped data 305, 310, and 315 (e.g., including but not limited to validation content, clinical trial testing data, etc.) which can be displayed, viewed, electronically transmitted, searched, copied, retrieved, annotated, navigated, and printed from client computing environments 320, 325, and 330, respectively.

In an illustrative operation, client computing environments 320, 325, and 330 can comprise one or more components that operatively communicate with server computing environment 360 over communications network 335 to provide requests for processed data based on scraped regulatory compliance data. In the illustrative operation, regulatory data scraping and processing engine 350 can execute one or more data scraping guidelines 347 executable on server computing environment 360 to provide one or more instructions to server computing environment 360 to scrape and process legacy content 342 and aggregate the scraped legacy content data to populate one or more content processing templates 340 according to one or more content template guidelines 349 to generate processed content based on scraped data 305, 310, 315 and electronically communicate the processed content 305, 310, and 315 to one or more cooperating client computing environments 320, 325, and/or 330 for further display and/or navigation. Additionally, in the illustrative operation, regulatory data scraping and processing engine 350 can process data comprising any of legacy content data 342, content processing templates 340, and content template guidelines 349 to generate reporting data 345. Also, as is shown in FIG. 3, client computing environments 320, 325, and 330 are capable of processed content 305, 310, and 315 using an exemplary computing application (not shown) for display and interaction to one or more participating users and/or cooperating parties (not shown).

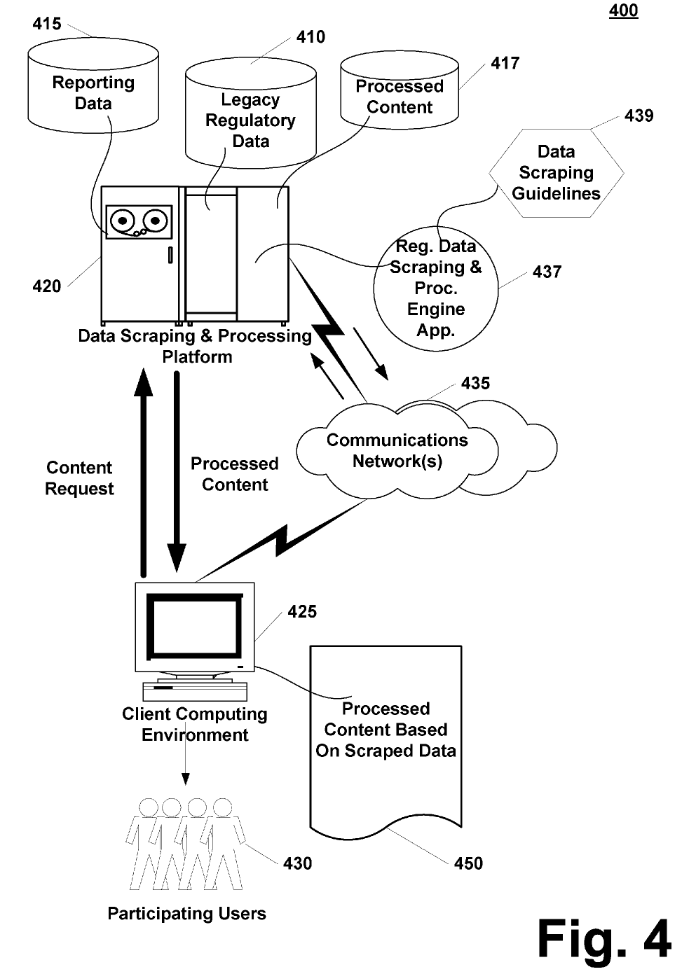

FIG. 4 shows a detailed illustrative implementation of an exemplary data scraping and processing environment 400. As is shown in FIG. 4, exemplary data scraping and processing environment 400 comprises data scraping and processing platform 420, reporting data store 415, processing content data store 417, legacy regulatory data store 410, regulatory data scraping and processing application 437, data scraping guidelines 439, cooperating client computing environment 425, participating users 430, and processed content based on scraped data 450.

In an illustrative implementation, data scraping and processing platform 420 can be electronically operatively coupled to client computing environment 425 via communications network 435. In the illustrative implementation, communications network 435 can comprise fixed-wire and/or wireless intranets, extranets, local area networks, wide area networks, and the Internet.

In an illustrative operation, one or more participating users (e.g., regulatory compliance data gatekeepers) can provide a request to data scraping and processing platform 420 for processed data based on scraped legacy data using client computing environment 425. Responsive to the request, data scraping and processing platform 420 can invoke regulatory data scraping and processing engine application 437 operable according to one or more data scraping guidelines 439 to process legacy regulatory data 410 for data scraping operations. The scraped data can then be illustratively processed by regulatory data scraping and processing engine application 437 according to one or more data scraping guidelines 439 to generate processed content 417 for communication to the requesting client computing environment 425. The requesting client computing environment 425 can then be used to display, navigate, and/or manipulate the communicated processed content based on the scraped data 450 to/by one or more of participating users 430. Further, in the illustrative operation, data scraping and processing engine application 437 can process legacy regulatory data 410 and processed content 417 to generate reporting data 415 for communication to client computing environment 425.

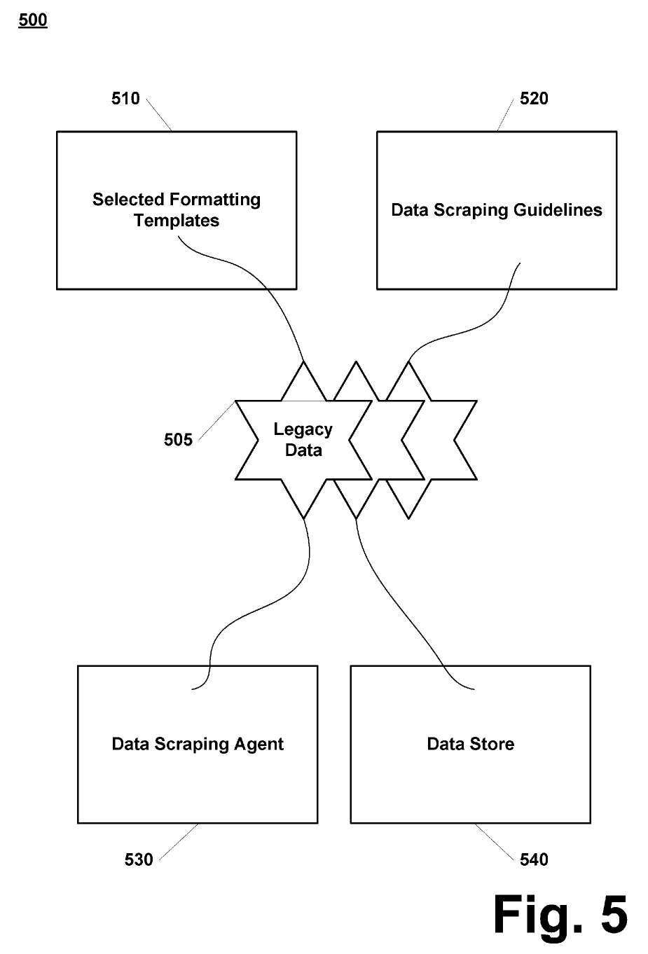

FIG. 5 shows an exemplary data scraping and processing environment 500. As is shown in FIG. 5, in an illustrative implementation, exemplary data scraping and processing environment 500 comprises legacy data 505 and having one or more cooperating components operating on legacy data 505 including but not limited to selected formatting templates 510, data scraping guidelines 520, data scraping agent 530, and data store 540.

In an illustrative operation, legacy data 505 can be processed by data scraping agent 530 according to one or more data scraping guidelines 530 to generate and aggregate scraped legacy data (not shown) for use in populating one or more selected formatting templates 510 for storage in data store 540. In an illustrative implementation, data scraping agent 530 can comprise a computing application (not shown) executing one or more data correlation/association algorithms operable to identify similar legacy data 505 using one or more data types (not shown) and/or based on the similarity of the legacy data 505 elements (e.g., data scraping guidelines 520) and to correlate/associate similar legacy data 505 to generate scraped legacy data (not shown).

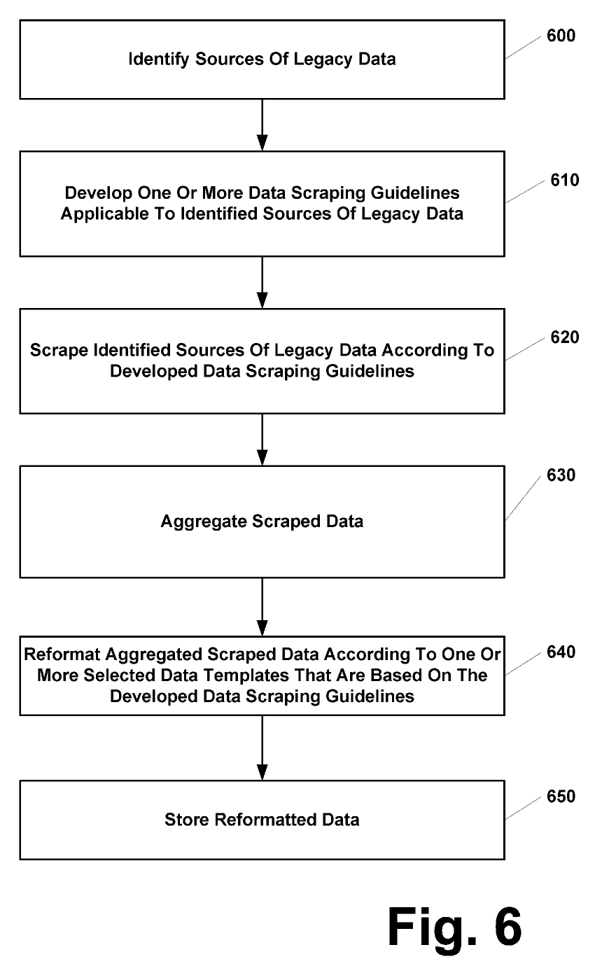

FIG. 6 shows exemplary processing performed by illustrative data scraping and processing platform 400 of FIG. 4 when processing legacy regulatory compliance data for data scraping operations. As is shown, processing begins at block 600 where one or more sources of legacy data is identified. Processing then proceeds to block 610 where one or more data scraping guidelines are developed that are applicable to the identified sources of legacy data. From there processing proceeds to block 620 where the identified sources of legacy data are scraped according to the developed data scraping guidelines. The scraped data is then aggregated at block 630. Processing then proceeds to block 640 where the aggregated scraped data is reformatted according to one or more selected data templates that are based on the developed data scraping guidelines. Processing then ends at block 650 where the reformatted data is stored.

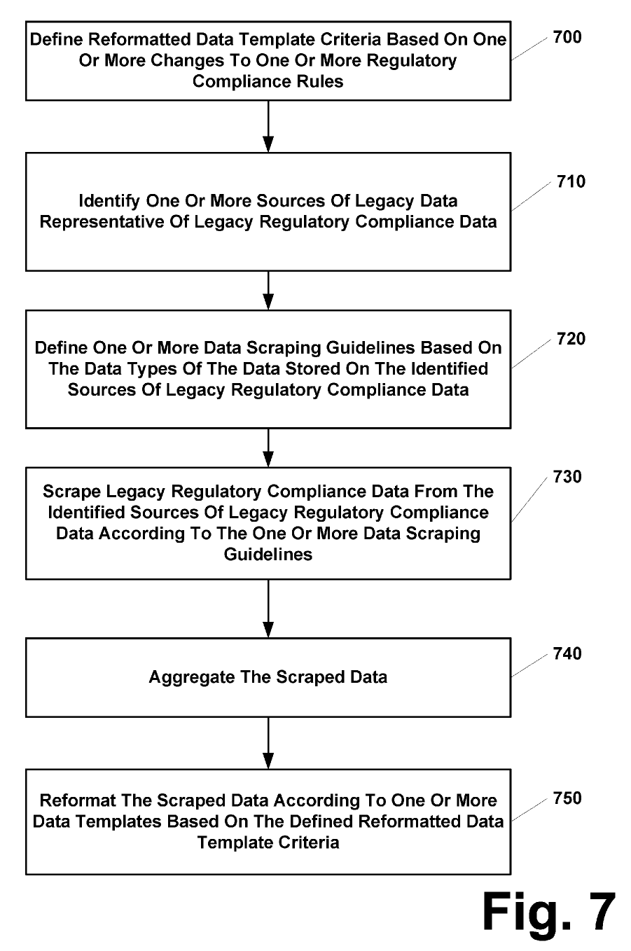

FIG. 7 shows exemplary processing performed by illustrative data scraping and processing platform 400 of FIG. 4 when processing legacy regulatory compliance data for data reformatting operations. As is shown, processing begins at block 700 where reformatted data template criteria are defined such that the data template criteria (e.g., data template criteria can illustratively comprise data concerning a particular regulation, piece of equipment, clinical trial, etc.) are based on one or more changes to one or more regulatory compliance rules. Processing then proceeds to block 710 where one or more sources of the legacy data representative of legacy regulatory compliance data are identified. From there, processing proceeds to block 720 where one or more data scraping guidelines are defined based on the data types of the data stored on the identified sources of legacy regulatory compliance data. Processing then proceeds to block 730 where the legacy regulatory compliance data from the identified sources of legacy regulatory compliance data is scraped according to one or more data scraping guidelines. The scraped data is then aggregated at block 740. The scraped data is then reformatted at block 750 according to one or more data templates that are defined based on the defined reformatted data template criteria.

It is appreciated that the term environment conditions is not meant to be limiting and can include but is not limited to one or more environment conditions which a cooperating one or more media/substrate experience including but not limited to the location of the media/substrate, the size of the media/substrate, traffic (e.g., number of people walking by, number of people driving by, size of vehicles passing by) proximate to the media/substrate (e.g., as ascertained by a cooperating traffic monitor—object counter), weather surrounding the media/substrate, etc.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus can also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The herein described systems and methods may be better defined by the following exemplary claims.

What is claimed is:

1. A regulatory data scraping and processing system comprising:
at least one data source having regulatory compliance and/or clinical trial data; and
a data scraping and processing manipulation engine operable to process data from the data source to identify one or more desired data according to a selected data scraping paradigm for use in generating a taxonomy for the identified data and for populating/creating, in real time, selected templates according to the generated taxonomy that are compliant with one or more regulatory compliance rules,
wherein the data taxonomy is representative of correlated relationships between the identified data according to the selected data scraping paradigm.

2. The system as recited in claim 1, further comprising one or more data stores operable to store data comprising processed content, reporting data, legacy regulatory compliance data, and non-legacy regulatory compliance data.

3. The system as recited in claim 1, wherein the data scraping and processing engine comprises a computing application.

4. The system as recited in claim 1, wherein the data scraping paradigm comprises one or more data scraping guidelines based on one or more selected criteria.

5. The system as recited in claim 4, wherein the one or more selected criteria comprises the type of regulation applying to the regulatory compliance data and changes to the regulation applying to the regulatory compliance data.

6. The system as recited in claim 4, wherein the one or more data scraping guidelines comprise at least one instruction set to process regulatory compliance data based on one or more regulatory compliance data characteristics comprising the type of regulatory compliance data, the subject matter of the regulatory compliance data, the location of the regulatory compliance data, the clinical trials described by the regulatory compliance data, and the facilities described by the regulatory compliance data.

7. The system as recited in claim 1, wherein the generated taxonomy is based on the data types of the regulatory compliance data.

8. The system as recited in claim 1, wherein the generated taxonomy is based on the subject matter of the regulatory compliance data.

9. The system as recited in claim 1, wherein the generated taxonomy is based on the clinical trials described by the regulatory compliance data.

10. The system as recited in claim 1, wherein the generated taxonomy is based on the facilities described by the regulatory compliance data.

11. A computer implemented method for performing data scraping and processing of regulatory compliance data for use in populating, in real time, one or more regulatory compliance data templates representative of one or more changes to regulatory compliance rules comprising:
receiving data representative of regulatory compliance data;
applying one or more data scraping guidelines to the received data to generate scraped regulatory compliance data;
aggregating scraped regulatory compliance data; and
populating the regulatory compliance data templates with the scraped regulatory compliance data.

12. The method as recited in claim 11, further comprising generating a taxonomy for the scraped regulatory compliance data for use in populating/creating, in real time, selected templates according to the generated taxonomy that are compliant with one or more regulatory compliance rules.

13. The method as recited in claim 12, further comprising generating a taxonomy for the scraped regulatory compliance data representative of correlated relationships between the identified data according to the selected data scraping paradigm.

14. The method as recited in claim 12, further comprising generating a taxonomy for the scraped regulatory compliance data based on one or more regulatory compliance data characteristics comprising the type of regulatory compliance data, the subject matter of the regulatory compliance data, the location of the regulatory compliance data, the clinical trials described by the regulatory compliance data, and the facilities described by the regulatory compliance data.

15. The method as recited in claim 11, further comprising generating processed content using the populated regulatory compliance data templates.

16. The method as recited in claim 15, further comprising generating reporting data representative of scraped regulatory compliance data and/or process content.

17. The method as recited in claim 15, further comprising storing the processed content.

18. The method as recited in claim 17, further comprising communicating the processed content to requesting party.

19. The method as recited in claim 11, further comprising receiving data representative of regulatory compliance data from one or more selected regulatory compliance data sources.

20. A computer readable medium comprising computer readable instructions to instruct a computer to perform a method comprising:
receiving data representative of regulatory compliance data;
applying one or more data scraping guidelines to the received data to generate scraped regulatory compliance data;
aggregating scraped regulatory compliance data; and
populating the regulatory compliance data templates with the scraped regulatory compliance data.
